(19) United States
(12) Patent Application Publication
(10) Pub. No.: US 2015/0054333 A1
(43) Pub. Date: Feb. 26, 2015

(54) Wheel with Tubeless Tire

(71) Applicant: Han-Tsung CHEN, Hua Tan Hsiang (TW)

(72) Inventor: Han-Tsung CHEN, Hua Tan Hsiang (TW)

(21) Appl. No.: 13/975,443

(22) Filed: Aug. 26, 2013

(51) Int. Cl. B60B 21/12; B60B 21/06; B60B 21/02

(52) U.S. Cl. CPC B60B 21/12; B60B 21/025; B60B 21/062
USPC 301/95.102

(57) ABSTRACT

A wheel includes a multi-layered rim, a sealing tape and a pressure-resistant tape. The multi-layered rim includes two layers. The first layer includes apertures for nipples. The second layer includes apertures corresponding to the apertures of the first layer. The sealing tape is used to wrap the second layer to seal the apertures of the second layer. The pressure-resistant tape is used to cover and support the sealing tape against high pressure.

### BACKGROUND OF INVENTION

1. Field of Invention

The present invention relates to a tubeless tire and, more particularly, to a wheel that includes a tubeless tire.

2. Related Prior Art

There are conventional tires and tubes, tubular tires and tubeless tires. Tubeless tires used for several reasons. At first, they are light. Secondly, a tubeless tire can be repaired without having to detach a wheel from a bicycle when it is burst. Hence, the cost and time for the repair are low. Thirdly, tubeless tires respond directly to the road surface, and this is good for riders to handle their bicycles.

There are single-layered rims and multi-layered rims. Multi-layered rims are used for rigidity. A tubeless tire requires a special multi-layered rim that includes a first layer made with a large aperture and small apertures and a second layer made with only one large aperture. The large apertures are used for a valve. The small apertures are used for nipples. Hence, it is difficult to remove debris that is produced during the making of the apertures since there is only one large aperture in the second layer. Moreover, it requires a special tool to insert the nipples into the small apertures through the large aperture of the first or second layer, and this is troublesome.

There are attempts to use a typical multi-layered rim that includes two layers each includes an aperture for a valve and apertures for nipples. For example, referring to FIGS. 4 and 5, a tape 95 is used to enable a typical multi-layered rim 9 to carry a tubeless tire 7. The typical multi-layered rim 9 includes two layers 91 and 93. The first layer 91 includes apertures 92. The second layer 93 includes apertures 94. A spoke 81 is engaged with a corresponding nipple 82 inserted into a corresponding aperture 92 through a corresponding aperture 94. The tape 95 is attached to the second layer 93 to seal the apertures 94. Finally, the tubeless tire 7 is connected to the typical multi-layered rim 9. However, under high pressure, portions of the tape 95 would be forced into the apertures 94 and fail to seal the apertures 94.

Referring to FIGS. 6 and 7, plugs 97 and a tape 98 are used to enable a multi-layered rim 90 to carry the tubeless tire 7. The multi-layered rim 90 includes two layers 91 and 93 and two retroflex edges 96. The first layer 91 includes apertures 92. The second layer 93 includes apertures 94. Each plug 97 is fit in a corresponding aperture 94 after a corresponding spoke 81 is engaged with a corresponding nipple 82 inserted into a corresponding aperture 92 through a corresponding aperture 94. Then, the tape 98 is used to wrap the plugs 97 and the second layer 93. The tape 93 is formed with two edges each inserted a grooved made in a corresponding retroflex edge 96 of the rim 90. Finally, the tubeless tire 7 is connected to the typical multi-layered rim 9. Thus, the apertures 94 are tightly sealed by the tape 98, which is well supported by the plugs 97. A gap between each edge of the tubeless tire 7 and a corresponding retroflex edge 96 of the rim 90 is tightly sealed by a corresponding edge of the tape 98, which is sandwiched between the corresponding edge of the tubeless tire 7 and the corresponding retroflex edge 96 of the multi-layered rim 90. However, the cost is high because the many plugs 97 have to be fit in the apertures 94 and the edges of the tape 98 have to be inserted in the grooves defined by the retroflex edges 96 of the multi-layered rim 90.

The present invention is therefore intended to obviate or at least alleviate the problems encountered in the prior art.

### SUMMARY OF INVENTION

It is the primary objective of the present invention to provide a light and inexpensive wheel.

To achieve the foregoing objectives, the wheel includes a multi-layered rim, a sealing tape and a pressure-resistant tape. The multi-layered rim includes two layers. The first layer includes apertures for nipples. The second layer includes apertures corresponding to the apertures of the first layer. The sealing tape is used to wrap the second layer to seal the apertures of the second layer. The pressure-resistant tape is used to cover and support the sealing tape against high pressure.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a partial, exploded view of a wheel according to the preferred embodiment of the present invention;

FIG. 2 is a cross-sectional view of the wheel shown in FIG. 1;

FIG. 3 is an enlarged partial view of the wheel shown in FIG. 1;

FIG. 4 is a cross-sectional view of a conventional wheel;

FIG. 5 is an enlarged partial view of the wheel shown in FIG. 4;

FIG. 6 is a partial, exploded view of another conventional wheel; and

FIG. 7 is a cross-sectional view of the wheel shown in FIG. 6.

### DETAILED DESCRIPTION OF PREFERRED EMBODIMENT

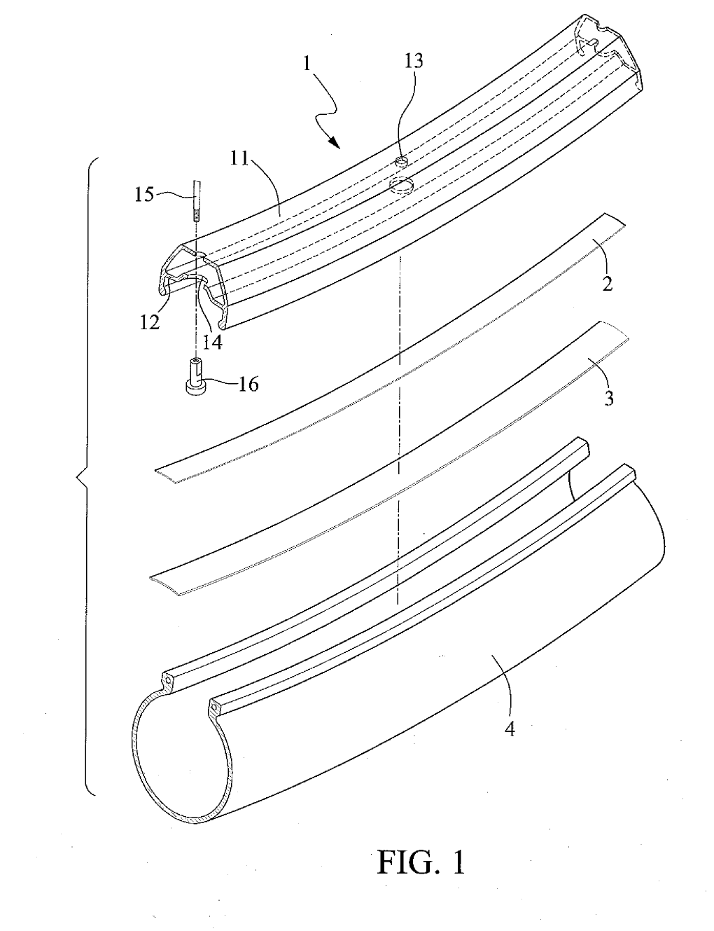

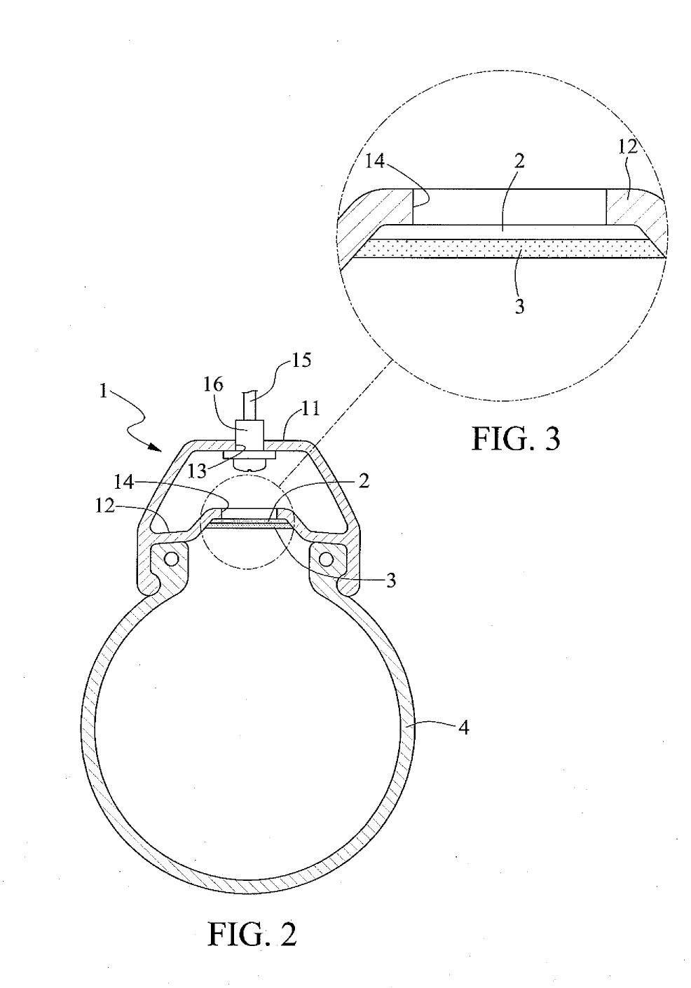

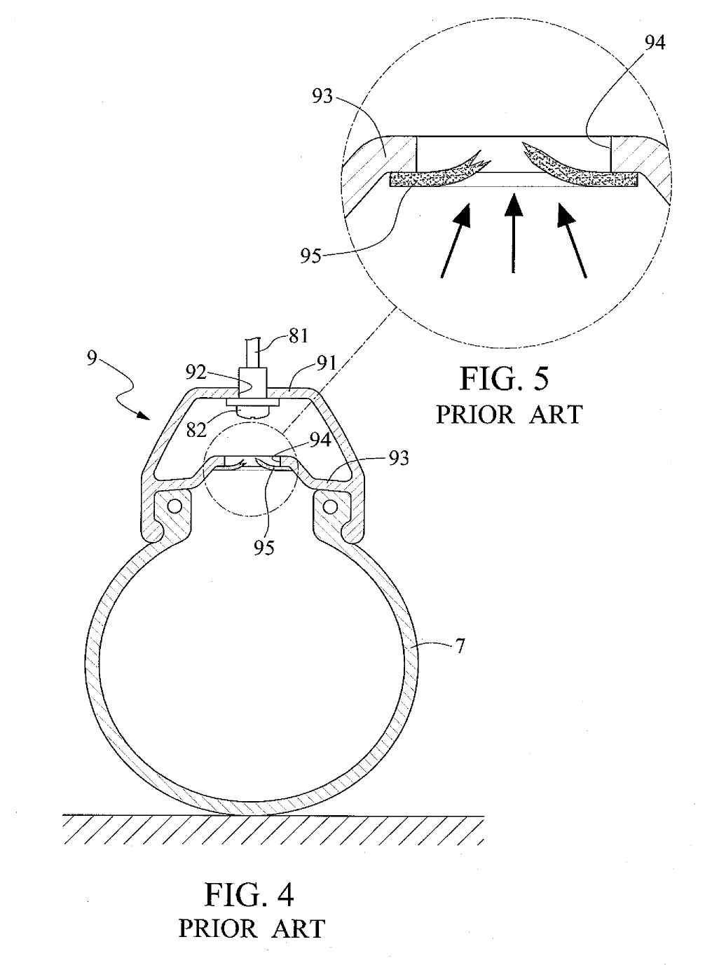

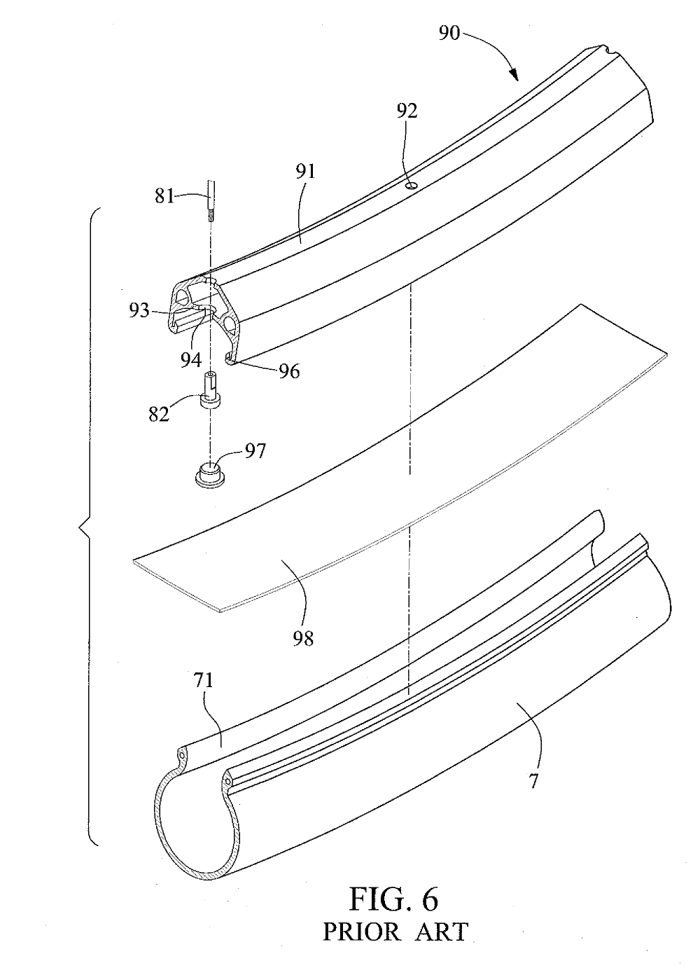

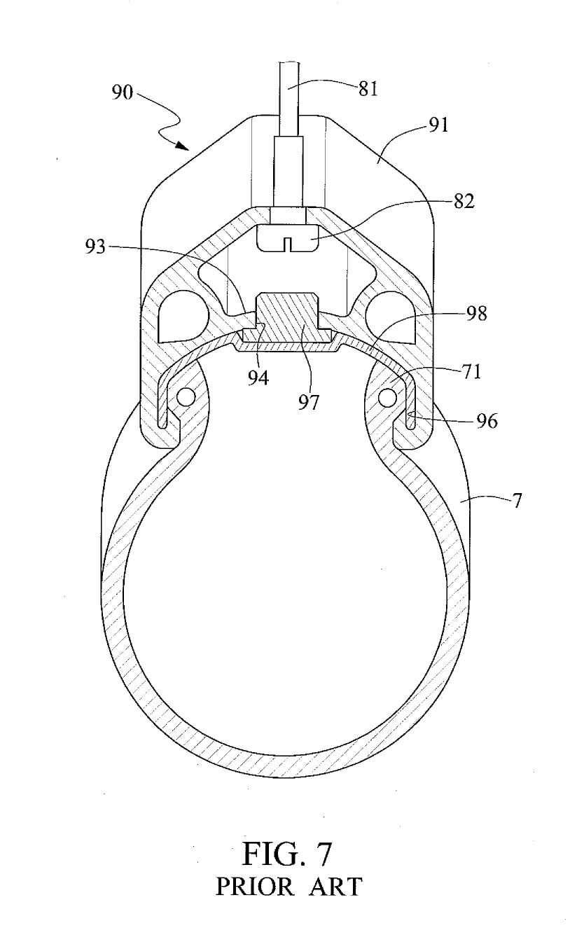

Referring to FIGS. 1 through 3, a wheel includes a multi-layered rim 1, a sealing tape 2, a pressure-resistant tape 3, a tireless tire 4, nipples 14, and spokes 15 according to the preferred embodiment of the present invention. The multi-layered rim 1 includes two layers 11 and 12. The first layer 11 includes apertures 13. The second layer 12 includes apertures 14 corresponding to the apertures 13.

The sealing tape 2 is made of an elastic material so that it can be in tight contact with the second layer 12 of the multi-layered rim 1. The sealing tape 2 is preferably in the form of a loop.

The pressure-resistant tape 3 is made of a relatively rigid material so that it can adequately support the sealing tape 2 against high pressure. The width of the pressure-resistant tape 3 is larger than that of the sealing tape 2.

Each spoke 15 is engaged with a corresponding nipple 16 inserted into a corresponding aperture 13 through a corresponding aperture 14. The sealing tape 2 is used to wrap the second layer 12 of the multi-layered rim 1 to seal the apertures 94 before the pressure-resistant tape 3 is used to cover the sealing tape 2. Preferably, adhesive can be provided between the sealing tape 2 and the second layer 12 of the multi-layered rim 1. Preferably, adhesive can be provided between the pressure-resistant tape 3 and the sealing tape 2. The tubeless tire 4 is connected to the multi-layered rim 1. Finally, pressurized air is pumped into a tubular space defined by multi-layered rim 1 and the tubeless tire 4.

Advantageously, the sealing tape 2 excellently seals the apertures 94 since the sealing tape 2, which is made of an elastic material, tightly wraps the second layer 12 of the multi-layered rim 1. The pressure-resistant tape 3, which is made of a relatively rigid material, supports the sealing tape 2 against high pressure, thus ensuring the sealing effect of the sealing tape 2.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A wheel including:
a multi-layered rim including a first layer including apertures for receiving nipples and a second layer including apertures corresponding to the apertures of the first layer;
a sealing tape for wrapping the second layer to seal the apertures of the second layer; and
a pressure-resistant tape for covering and supporting the sealing tape against high pressure.

2. The wheel according to claim 1, wherein the sealing tape is in the form of a loop.

3. The wheel according to claim 1, wherein the sealing tape is made of an elastic material.

4. The wheel according to claim 3, wherein the pressure-resistant tape is made of a relatively rigid material.

5. The wheel according to claim 4, wherein the pressure-resistant tape is made with a width larger than that of the sealing tape.

6. The wheel according to claim 1, including adhesive provided between the sealing tape and the second layer of the multi-layered rim.

7. The wheel according to claim 1, including adhesive provided between the pressure-resistant tape and the sealing tape.
